(19) United States
(12) Patent Application Publication
(10) Pub. No.: US 2025/0389374 A1
(43) Pub. Date: Dec. 25, 2025

(54) CONTROL METHOD OF HANDHELD GIMBAL, DEVICE, AND STORAGE MEDIUM

(71) Applicant: Arashi Vision Inc., Shenzhen (CN)

(72) Inventors: Dehua MO, Shenzhen (CN); Guogang LV, Shenzhen (CN); Xianhong JIANG, Shenzhen (CN); Gu CHEN, Shenzhen (CN); Lifen LU, Shenzhen (CN)

(73) Assignee: Arashi Vision Inc., Shenzhen (CN)

(21) Appl. No.: 19/246,730

(22) Filed: Jun. 24, 2025

(30) Foreign Application Priority Data
Jun. 24, 2024 (CN) 202410825682.3

(51) Int. Cl. F16M 11/12; F16M 13/04

(52) U.S. Cl. CPC F16M 11/123; F16M 13/04

(57) ABSTRACT

A control method for a handheld gimbal is provided. The handheld gimbal may comprise a handle and a rotating assembly connected to the handle. The rotating assembly may be configured to carry a shooting device and drive the shooting device to rotate. The control method may comprise acquiring a posture of the rotating assembly and a posture of the handle; determining a posture difference between the rotating assembly and the handle according to the posture of the rotating assembly and the posture of the handle; and determining that the handheld gimbal is in a side shooting mode according to the posture difference.

### CROSS-REFERENCE TO RELATED APPLICATION

This application claims the priority of Chinese Patent Application No. 202410825682.3, filed Jun. 24, 2024, the contents of which is incorporated into the present disclosure in its entirety.

### TECHNICAL OF FIELD

The present application relates to a field of image processing technology, and in particular to a control method, device, computer equipment, storage medium and computer program product for a handheld gimbal.

### BACKGROUND

Handheld gimbals have become an important shooting tool for photography enthusiasts. However, in an actual application, a user needs to switch freely between different shooting modes to meet the shooting needs of various scenes. For example, when switching to a side shooting mode, the user may need to adjust an attitude of a gimbal to capture a more unique perspective.

The above information disclosed in the background section of this application is only used to understand the background of the concept of this application, and may contain information that does not constitute prior art.

### SUMMARY

In one embodiment, a control method for a handheld gimbal is provided. The handheld gimbal may comprise a handle and a rotating assembly connected to the handle. The rotating assembly may be configured to carry a shooting device and drive the shooting device to rotate. The control method may comprise acquiring a posture of the rotating assembly and a posture of the handle; determining a posture difference between the rotating assembly and the handle according to the posture of the rotating assembly and the posture of the handle; and determining that the handheld gimbal is in a side shooting mode according to the posture difference.

In another embodiment, a control device for a handheld gimbal is provided. The gimbal may include a rotating assembly and a handle, the rotating assembly may be configured to carry a shooting device and drive a shooting device to rotate. The control device may include at least one memory and at least one processor, wherein the at least memory stores a computer program, wherein the at least one processor, when executing the computer program, is configured to acquire an attitude of the rotating assembly and an attitude of the handle; determine an attitude difference between the rotating assembly and the handle according to the attitude of the rotating assembly and the attitude of the handle; and determine that the handheld gimbal is in a side shooting mode according to the attitude difference.

In another embodiment, a handheld gimbal is provided. The handheld gimble may include a handle and a rotating assembly connected to the handle, the rotating assembly configured to carry a shooting device and drive the shooting device to rotate. The handheld gimbal may further comprises circuitry configured to acquire an attitude of the rotating assembly and an attitude of the handle; determine an attitude difference between the rotating assembly and the handle according to the attitude of the rotating assembly and the attitude of the handle; and determine that the handheld gimbal is in a side shooting mode according to the attitude difference.

It is to be understood that the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a diagram showing an application environment of a method for controlling a handheld gimbal according to an embodiment;

FIG. 2 is a schematic flow chart of a control method of a handheld gimbal according to an embodiment;

FIG. 3 is a schematic diagram of a structure of a side shooting mode according to an embodiment;

FIG. 4 is a schematic diagram of a structure of a front shooting mode according to an embodiment;

FIG. 5 is a schematic diagram of a structure of a front shooting mode according to an embodiment;

FIG. 6 is a block diagram of a control device for a handheld gimbal according to an embodiment;

FIG. 7 is a diagram showing an internal structure of a computer device according to an embodiment.

100—shooting device; 210—first motor; 220—second motor; 230—third motor; 300—handle.

### DETAILED DESCRIPTION

Exemplary embodiments will be described in detail herein, examples of which are shown in the accompanying drawings. When the following description refers to the drawings, the same numbers in different drawings represent the same or similar elements unless otherwise indicated. The embodiments described in the following exemplary embodiments do not represent all embodiments consistent with the present disclosure. Instead, they are merely examples of devices and methods consistent with some aspects of the present disclosure as detailed in the appended claims.

In the description of the embodiments of the present application, the technical terms “first”, “second”, “third,” etc. are merely used for distinguishing different objects, and are not to be construed as indicating or implying relative importance or implicitly indicating the number, particular order or primary-secondary relationship of the indicated technical features. In the description of the embodiments of the present application, the singular forms of “a,” “an,” and “the” used in this specification and the appended claims are also intended to encompass the plurality, unless the context clearly indicates otherwise. It should also be understood that the term “and/or” as used herein refers to and encompasses any or all possible combinations of one or more of the associated listed items.

Currently, when a handheld gimbal is adjusted by a user to adjust a shooting mode, the handheld gimbal cannot accurately or quickly recognize the user's operation. Some embodiments of the present application may solve this technical problem by detecting changes in an attitude of the handheld gimbal.

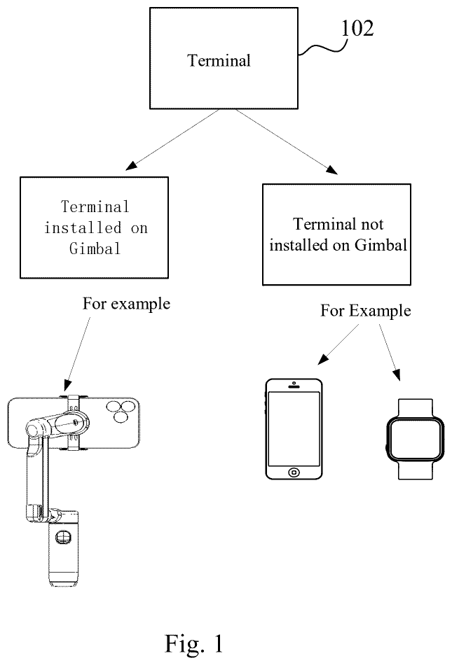

A control method of a handheld gimbal provided in one embodiment of the present application can be applied in an application environment shown in FIG. 1. A terminal 102 can be, but is not limited to, one of various cameras such as video cameras, panoramic cameras, and sports cameras, personal computers, laptop computers, smart phones, tablet computers, or portable wearable devices, and the portable wearable devices can be smart watches, smart bracelets, head-mounted devices, etc. The terminal 102 can be fixed to a gimbal body by welding or the like and can also be detachably connected or rotatably connected to the gimbal body.

In an exemplary embodiment, the handheld gimbal includes a handle and a rotating assembly connected to the handle, and the rotating assembly is used to carry a shooting device or structure and drive the shooting device to rotate.

In an exemplary embodiment, a rotating assembly may be used to carry a shooting device and drive the shooting device to rotate. The rotating assembly includes a carriage for mounting the shooting device and one or more joints for rotation; and the carriage is connected to a joint, and each joint can rotate about its own axis. Optionally, the carriage includes, but is not limited to, a clamp, magnetic alignment clip, or a buckle.

In an exemplary embodiment, a handle is a gripping part connected to the rotating assembly. The handle and the rotating assembly can be connected in a rotational manner, which means that the handle can rotate relative to the rotating assembly as a whole. Optionally, the handle and the rotating assembly are connected through a rotating mechanism so that the rotating assembly can rotate relative to the handle; optionally, the handle and the rotating assembly can be connected to the rotating mechanism through an extension rod, so that the distance between the handle and the rotating assembly can be changed through the extension rod, and the rotating assembly can rotate relative to the handle through the rotating mechanism.

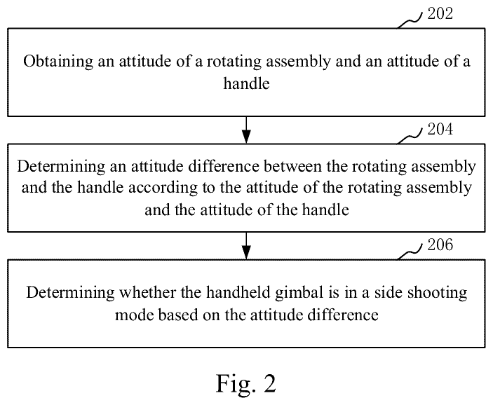

In an exemplary embodiment, as shown in FIG. 2, a control method for a handheld gimbal is provided, and the handheld gimbal control method is applied to the terminal 102 in FIG. 1 as an example for description, and may include the following steps:
Step 202: obtaining an attitude of a rotating assembly and an attitude of a handle.

The attitude of the rotating assembly may characterize a position of the rotating assembly and its rotating attitude. Through the attitude of the rotating assembly, the rotating assembly can be distinguished from other components contained in the handheld gimbal, forming an attitude dimension of the rotating assembly. This attitude dimension is a dimension of from the handheld gimbal refining to the components. Since the rotating assembly includes multiple components, an attitude of a certain component can be used as the attitude of the rotating assembly. The attitude of the rotating assembly can also be determined based on attitudes of multiple components.

The handle attitude may characterize a position and an attitude of the handle. Through the handle attitude, the handle can be distinguished from other components contained in the handheld gimbal, forming an attitude dimension of the handle. This attitude dimension is a dimension of from the handheld gimbal refining to the components. Since there are many ways to connect the rotating assembly and the handle, the rotating assembly and the handle may have completely different attitudes.

For example, when the rotating assembly and the handle are rotatably connected via a rotating mechanism, the attitude difference between the rotating assembly and the handle can be changed via the rotating mechanism; and/or, when the rotating assembly and the handle are connected via a telescopic rod, the attitude difference between the rotating assembly and the handle can be changed via the telescopic rod.

Optionally, the attitudes of the rotating assembly and the handle can be detected by motion sensors, and the attitudes of the rotating assembly and the handle can be obtained simultaneously or separately. The rotating assembly and the handle can be detected by an optical or Hall sensor to obtain the attitudes of the rotating assembly and the handle simultaneously; the rotating assembly and the handle can be detected by optical or Hall sensors respectively to obtain the attitudes of the rotating assembly and the handle separately. The attitudes of the rotating assembly and the handle can also be obtained separately by motion sensors respectively provided on the rotating assembly and the handle, so that the attitudes of the two components are more accurate.
Step 204: determining an attitude difference between the rotating assembly and the handle according to the attitude of the rotating assembly and the attitude of the handle.

The attitude difference represents a difference in attitudes between the rotating assembly and the handle. The attitude difference may include an angle difference, so as to reflect a degree of attitude difference of the rotating assembly relative to the handle through the angle difference and enable control through the degree of attitude difference. Optionally, the attitude difference includes an angle difference under a certain condition so as to analyze a specific degree of attitude difference in more detail, thereby reflecting a degree of change of the rotating assembly relative to the handle.

In an optional embodiment, determining the attitude difference between the rotating assembly and the handle according to the attitude of the rotating assembly and the attitude of the handle includes: calculating a difference angle according to the attitude of the rotating assembly and the attitude of the handle to obtain the attitude difference between the rotating assembly and the handle.

In an optional embodiment, determining the attitude difference between the rotating assembly and the handle according to the attitude of the rotating assembly and the attitude of the handle includes: if the attitude of the rotating assembly meets a side shooting attitude in the world coordinate system, calculating the difference angle according to the attitude of the rotating assembly and the attitude of the handle to obtain the attitude difference between the rotating assembly and the handle. Thus, for the rotating assembly, the attitude condition is set in the world coordinate system to more accurately determine the attitude difference.

In an optional embodiment, determining the attitude difference between the rotating assembly and the handle according to the attitude of the rotating assembly and the attitude of the handle includes: if the attitude of the rotating assembly and the attitude of the handle belong to a same reference coordinate system, performing attitude difference analysis based on the attitude of the rotating assembly and the attitude of the handle to obtain the attitude difference between the rotating assembly and the handle. The attitude difference analysis can be performed by at least one of rotation matrix product, rotation matrix difference, Rodriguez formula, quaternion product or quaternion difference.

In an optional embodiment, determining the attitude difference between the rotating assembly and the handle based on the attitude of the rotating assembly and the attitude of the handle includes: if the attitude of the rotating assembly belongs to a rotating assembly coordinate system and the attitude of the handle belongs to a handle coordinate system, converting the attitude of the rotating assembly to the reference coordinate system to obtain the attitude of the rotating assembly in the reference coordinate system; converting the attitude of the handle to the reference coordinate system to obtain the attitude of the handle in the reference coordinate system; based on the attitude of the rotating assembly in the reference coordinate system and the attitude of the handle in the reference coordinate system, performing the attitude difference analysis to obtain the attitude difference between the rotating assembly and the handle. Among them, the attitude difference analysis can be performed by at least one of rotation matrix product, rotation matrix difference, Rodriguez formula, quaternion product or quaternion difference.
Step 206: determining whether the handheld gimbal is in a side shooting mode based on the attitude difference.

The side shooting mode is a control method of the handheld gimbal, which is used to control the handheld gimbal to drive the shooting device to rotate. As entering the side shooting mode based on the attitude difference is close to automatic processing, its accuracy is relatively high. This entry process is not restricted by buttons or interfaces and has high convenience. Optionally, the side shooting mode is used to regulate a rotation range of the rotating assembly so that a controllable range of the shooting device in different directions can be adjusted. Optionally, if in a front shooting mode, the controllable range of the rotating assembly in the yaw direction is greater than the controllable range in pitch direction, then in the side shooting mode, the controllable range of the rotating assembly in the pitch direction is greater than the controllable range in the yaw direction. The controllable range can be a joint angle range, or it can be a range of attitude changes of a mechanical arm such as a shaft arm.

In an optional embodiment, determining whether the handheld gimbal is in the side shooting mode based on the attitude difference includes: detecting an angle interval in which the difference angle is located; if the difference angle is in a side shooting angle interval, controlling the handheld gimbal to be in the side shooting mode.

In an optional embodiment, determining whether the handheld gimbal is in the side shooting mode based on the attitude difference includes: if the difference angle meets a direction condition, comparing the difference angle with a threshold; if it is greater than the threshold, controlling the handheld gimbal to be in the side shooting mode.

In some embodiments, in the control method of the handheld gimbal, when the handle is connected to the rotating assembly, the attitude of the rotating assembly and the attitude of the handle can be obtained, which means that the rotating assembly and the handle in the handheld gimbal form two components with independent attitudes, forming the control basis of the handheld gimbal in the component dimension. On this basis, the attitude difference is determined according to the attitudes of the two components, and the attitude difference is used as the control parameter of the component dimension. Then, according to the attitude difference, it is accurately determined that the handheld gimbal is in the side shooting mode, so as to control the rotation of the rotating assembly of the handheld gimbal according to the side shooting mode and drive the shooting device to shoot.

In an exemplary embodiment, the attitude of the rotating assembly is determined by a motion sensor on the rotating assembly or a motion sensor on the shooting device, and the attitude of the handle is detected by a motion sensor provided in the handle.

The motion sensor may be a sensor that senses motion of a certain part of the handheld gimbal. The motion sensor includes, but is not limited to, one or more of an accelerometer, an angular velocity sensor, a gyroscope, or a magnetometer. Optionally, the motion sensor may be an inertial measurement unit (IMU) to output an attitude of the corresponding part through the IMU.

The rotating assembly may be connected to the handle, and the rotating assembly may be used to carry the shooting device and drive the shooting device to rotate. In this case, relative to the attitude of the handle, the attitudes of the rotating assembly and the shooting device are synchronized, so the attitude of the rotating assembly can be determined by the motion sensor on the rotating assembly or the motion sensor on the shooting device.

In an optional embodiment, obtaining the attitude of the rotating assembly and the attitude of the handle includes: determining the attitude of the rotating assembly through a motion sensor on the rotating assembly or a motion sensor on a shooting device; and detecting the attitude of the handle through a motion sensor provided in the handle.

In an optional embodiment, determining the attitude of the rotating assembly by a motion sensor on the rotating assembly or a motion sensor on the shooting device includes: detecting the attitude of the rotating assembly by the motion sensor on the rotating assembly to obtain the attitude of the rotating assembly; or detecting the attitude of the shooting device by the motion sensor on the shooting device to obtain the attitude of the shooting device, and using the attitude of the shooting device as the attitude of the rotating assembly; or detecting the attitude of the rotating assembly by the motion sensor on the shooting device to obtain the attitude of the rotating assembly.

In an optional implementation, detecting the attitude of the handle by a motion sensor disposed inside the handle includes: detecting the attitude of the handle by a motion sensor disposed inside the handle to obtain the attitude of the handle. For example, a motion sensor based on a Hall sensor can be used to detect the attitude of the handle

In this embodiment, at least one of the rotating assembly or the shooting device has a motion sensor, so that the attitude of the rotating assembly can be determined from different angles to ensure accuracy. By using motion sensors at different positions to obtain the attitudes of the rotating assembly and the handle respectively, these two attitudes can be obtained more timely.

In an exemplary embodiment, the rotating assembly includes a motor; obtaining the attitude of the rotating assembly: detecting a joint angle of the motor and an attitude of the motor; converting the attitude of the motor into the attitude of the rotating assembly according to the joint angle of the motor.

The joint angle may be an angle at which the motor drives its own joint to rotate. By detecting the joint angle of the motor, the angle of the motor in a direction of its own rotation can be determined in detail. Optionally, when there are multiple motors, the joint rotation is controlled by multiple motors respectively, and the joint angle of each motor provides an adjustment dimension for the rotation of the rotating assembly, so that the attitude of the rotating assembly can be changed in multiple adjustment dimensions.

The attitude of the motor may characterize a position of the motor. Since the motor is a part of the rotating assembly, the attitude of the motor is actually the attitude of the rotating assembly at a certain position. On this basis, since the joint angle of the motor can be used to adjust the attitude of the rotating assembly, the attitude of the motor can be converted to that of a certain component of the rotating assembly, so as to accurately determine the attitude difference.

Optionally, detecting the joint angle of the motor and the attitude of the motor includes: detecting the joint angle of the motor by an angle sensor, and detecting the attitude of the motor by an attitude sensor.

Optionally, detecting the joint angle of the motor and the attitude of the motor includes: detecting the joint angle of the motor and the attitude of the motor through an IMU.

Optionally, converting the attitude of the motor into the attitude of the rotating assembly according to the joint angle of the motor includes: converting the attitude of the motor into the attitude of the rotating assembly at a target position according to the joint angle of the motor to obtain the attitude of the rotating assembly.

In an optional implementation, detecting the joint angle and the attitude of the motor includes: determining the attitude of the rotating assembly through a motion sensor on the rotating assembly or a motion sensor on the shooting device, and detecting the joint angle and the attitude of the motor.

Correspondingly, obtaining the attitude of the handle includes: detecting the attitude of the handle through a motion sensor provided in the handle.

In this embodiment, the attitude of the rotating assembly and the attitude of the handle are obtained separately, and the mutual interference between the two is reduced. At the same time, the rotating assembly drives the motor to rotate its own joint through the motor. At this time, the joint angle of the motor and the attitude of the motor are detected, and multiple dimensions of the rotating assembly in the rotation process can be formed through the joint angles, so that the attitude of the motor can be converted to that of a certain component of the rotating assembly, so as to accurately determine the attitude difference.

In an exemplary embodiment, the rotating assembly includes a first motor, a second motor, and a third motor that rotate in different directions, and the first motor, the second motor, and the third motor are sequentially distributed between the shooting device and the handle.

The first motor, the second motor, and the third motor rotate in different directions, so the three motors can drive the shooting device to rotate in different directions. Although only two motors in two directions may be required to adjust arbitrarily in the horizontal and vertical directions by rotating the assembly, the use of three motors for adjustment to form three degrees of freedom can reduce restriction on the freedom of rotation in the vertical and horizontal directions, thereby achieving more complex motion patterns and higher stability of the shooting device.

Since the three motors are distributed in sequence between the shooting device and the handle, among the three motors, the first motor is closest to the shooting device, so that the attitude of the first motor is closest to the attitude of the shooting device. Correspondingly, the third motor is closest to the handle, so that the attitude of the third motor is closest to the attitude of the handle.

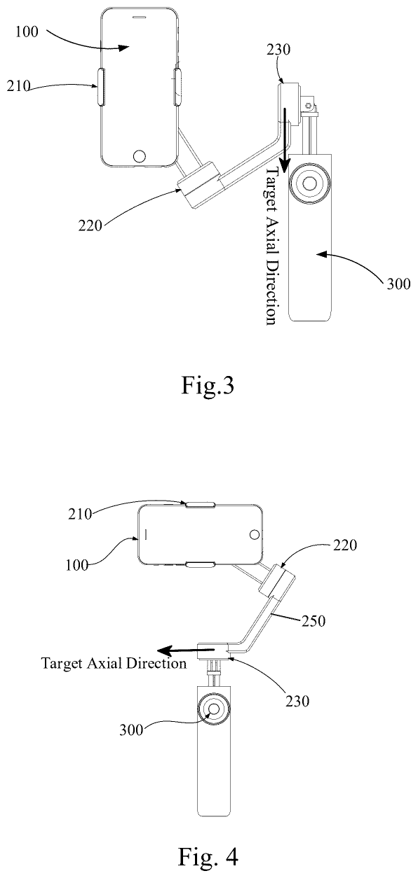

In an optional embodiment, as shown in FIG. 3, the shooting device 100 is carried on the first motor 210 through a clamp; the first motor 210, the second motor 220 and the third motor 230 can be connected in sequence through a shaft arm respectively, and the third motor 230 is connected to the handle 300. Thus, through the shaft arm connection, the three motors can influence and coordinate with each other to achieve multi-dimensional movement of the gimbal.

In an optional embodiment, converting the attitude of the motor into the attitude of the rotating assembly according to the joint angle of the motor includes: determining the joint angles of the first motor, the second motor and the third motor respectively; converting the attitude of the first motor through the joint angle of each motor to obtain the attitude of the rotating assembly.

Each joint angle includes at least a joint angle of the first motor, a joint angle of the second motor and a joint angle of the third motor. Optionally, if there are multiple first motors, there are multiple joint angles of the first motors; if there are multiple second motors, there are multiple joint angles of the second motors; if there are multiple third motors, there are multiple joint angles of the third motors.

The attitude of the first motor may characterize a position of the first motor, which may be the attitude of the rotating assembly at the first motor. On this basis, since the joint angle of each motor can be used to adjust the attitude of the rotating assembly, the attitude of the first motor can be converted to that of a certain part of the rotating assembly, so as to accurately determine the attitude difference.

In an optional embodiment, determining the joint angles of the first motor, the second motor, and the third motor includes: detecting the joint angle of the first motor through a sensor of the first motor at the joint driven by the first motor or the shaft arm connected to the first motor; detecting the joint angle of the second motor through a sensor of the second motor at the joint driven by the second motor or the shaft arm connected to the second motor; detecting the joint angle of the third motor through a sensor of the third motor at the joint driven by the third motor or the shaft arm connected to the third motor. Thus, the sensors of the joint positions are installed in cascade, and the angle of each joint can be measured to obtain the joint angle.

In an optional embodiment, the first motor, the second motor and the third motor are respectively provided with angle sensors. Determining the joint angles of the first motor, the second motor and the third motor includes: detecting the joint angles of the first motor, the second motor and the third motor respectively through the angle sensors.

The angle sensors are respectively arranged on the first motor, the second motor and the third motor, so at least each motor is provided with an angle sensor, so as to detect the rotation angle of the joint driven by the respective motor through each angle sensor. Optionally, the angle sensor can be a Hall sensor.

In an exemplary embodiment, detecting the joint angles of the first motor, the second motor and the third motor respectively by angle sensors includes: detecting the joint angle of the first motor by an angle sensor provided in the first motor; detecting the joint angle of the second motor by an angle sensor provided in the second motor; and detecting the joint angle of the third motor by an angle sensor provided in the third motor.

In an exemplary embodiment, detecting the joint angles of the first motor, the second motor and the third motor respectively by angle sensors includes: detecting the joint angle of the first motor by an angle sensor installed on the shaft arm connected to the first motor; detecting the joint angle of the second motor by an angle sensor installed on the shaft arm connected to the second motor; and detecting the joint angle of the third motor by an angle sensor installed on the shaft arm connected to the third motor.

In this embodiment, the joint angles of the first motor, the second motor and the third motor are obtained by angle detection through respectively arranged angle sensors. Thus, the joint angles can be detected more efficiently, so that the terminal can obtain the joint angles in real time, thereby increasing accuracy of attitude conversion based on the joint angles.

In an optional embodiment, the first motor is connected to the shooting device, the third motor is connected to the handle, the attitude of the third motor is obtained by converting the attitude of the first motor through the joint angle of each motor, and the attitude of the third motor is the attitude of the rotating assembly.

Optionally, the first motor and the shooting device are detachable, rotatable, or non-detachable. When the first motor is connected with a mobile phone clamp having an angler, or a magnet, and is connected to the shooting device through the mobile phone clamp having the angler, or the magnet, the connection between the first motor and the shooting device is a detachable connection; when the first motor and the shooting device are welded, threaded, or connected through a non-detachable mobile phone clamp, the connection between the first motor and the shooting device is a non-detachable connection.

In one embodiment, the attitude of the third motor may characterize the position of the third motor. The attitude of the rotating assembly is the attitude of the third motor. On this basis, since the joint angle of each motor can be used to adjust the attitude of the rotating assembly, and since the third motor is connected to the handle, the attitude difference between the third motor and the handle can more accurately reflect the degree of rotation between the rotating assembly and the handle so as to accurately determine the attitude difference.

In an exemplary embodiment, converting the attitude of the first motor through the joint angle of each motor to obtain the attitude of the rotating assembly includes: according to the respective joint angles of the first motor, the second motor and the third motor, converting the attitude of the first motor to obtain the attitude of the third motor, wherein the attitude of the third motor is the attitude of the rotating assembly.

In an exemplary embodiment, converting the attitude of the first motor through the joint angle of each motor to obtain the attitude of the rotating assembly includes: determining quaternions of the first motor, the second motor and the third motor according to their respective joint angles; converting the attitude of the first motor according to their respective quaternions to obtain the attitude of the third motor; and the attitude of the third motor is the attitude of the rotating assembly.

In this embodiment, the first motor is connected to the shooting device, so that the attitude of the first motor is closer to the attitude of the shooting device, and the third motor is connected to the handle, so that the attitudes of the third motor and the handle are closer. In this case, the attitude of the first motor is converted through the joint angle of each motor until the attitude of the third motor is obtained, and the attitude of the third motor is used as the attitude of the rotating assembly, so that the attitude deviation between the rotating assembly and the handle can be smaller, so as to more accurately determine that the handheld gimbal is in the side shooting mode.

Based on this, since the attitude of the handle is determined by the motion sensor set by the handle, the attitude of the handle is decoupled from the attitude of the rotating or shaft assembly, and the accuracy of the attitude of the handle is not affected by the change of the adjustable direction of the shaft assembly; and the attitude of the shooting device is detected by the device attitude sensor set by the shaft assembly. This attitude and the attitude of the handle are obtained by detecting different components at different positions, so the dimensions of the two are different. On this basis, the joint angle of each motor is detected by the angle sensor set by each motor, and the attitude of the shooting device is converted into the attitude of the third motor according to the joint angles. Since the joint angle reflects the influence of each motor on the attitude of the shooting device, the attitude of the third motor can represent the attitude of the shaft assembly; therefore, information processing can be performed based on the attitude of the two dimensions of the attitude of the handle and the attitude of the third motor to accurately determine whether the handle is in the side shooting mode or the front shooting mode.

In an optional embodiment, converting the attitude of the first motor through the joint angle of each motor to obtain the attitude of the rotating assembly includes: determining a rotation matrix of the first motor, a rotation matrix of the second motor and a rotation matrix of the third motor according to the respective joint angles of the first motor, the second motor and the third motor; combining the attitude of the first motor with the rotation matrix of the first motor, the rotation matrix of the second motor and the rotation matrix of the third motor to obtain the attitude of the rotating assembly.

The rotation matrix may include an angle of rotation of the motor-driven joint. Since the first motor, the second motor and the third motor are all used to drive the rotation of their own joints, the directions of the rotation matrix belong to the directions of the three motors driving their own key rotations, resulting in the direction of the rotation matrix relative to the motor's own joint being fixed. Therefore, the rotation matrix in the direction in which each motor can drive itself to rotate can be obtained through the joint angle.

Optionally, the first motor, the second motor and the third motor are all connected by a shaft arm so that a distance between two of the motors is a length of the shaft arm. Therefore, based on the rotation matrix of each of the three motors and the distance among the motors, the attitude of each motor can be determined.

Optionally, the distances among the first motor, the second motor and the third motor are set by a mechanical structure and are detectable, so that the attitude of each motor can be determined based on the rotation matrices of the three motors and the distance between each two of the motors.

In a feasible implementation, determining the rotation matrix of the first motor, the rotation matrix of the second motor, and the rotation matrix of the third motor according to their respective joint angles includes: converting the joint angle of the first motor, the joint angle of the second motor, and the joint angle of the third motor into matrices respectively to obtain the rotation matrix of the first motor, the rotation matrix of the second motor, and the rotation matrix of the third motor.

Correspondingly, combining the attitude of the first motor with the rotation matrix of the first motor, the rotation matrix of the second motor and the rotation matrix of the third motor to obtain the attitude of the rotating assembly includes: multiplying or adding the attitude of the first motor with the rotation matrix of the first motor, the rotation matrix of the second motor and the rotation matrix of the third motor to obtain the attitude of the rotating assembly.

In an optional implementation, the attitude of the first motor is determined by a motion sensor on the first motor or a motion sensor on the shooting device.

The motion sensor on the first motor may be a sensor for sensing the motion of the first motor. The motion sensor includes, but is not limited to, one or more of an acceleration sensor, an angular velocity sensor, a gyroscope, or a magnetometer. Optionally, the motion sensor may be an inertial measurement unit (IMU) to output the attitude of the first motor through the IMU.

Since the first motor is located closest to the shooting device among the first motor, the second motor and the third motor, the attitude of the first motor is closer to the shooting device relative to the attitudes of the handle, the second motor and the third motor. Therefore, the attitude of the first motor can be determined by the motion sensor on the first motor or the motion sensor on the shooting device.

In an exemplary embodiment, converting the attitude of the first motor through the joint angle of each motor to obtain the attitude of the rotating assembly includes: after determining the attitude of the first motor through a motion sensor on the first motor or a motion sensor on a shooting device, converting the attitude of the first motor through the joint angle of each motor to obtain the attitude of the rotating assembly.

In this embodiment, a motion sensor is provided on the first motor or the shooting device, so that the attitude of the first motor can be detected from the component level of the first motor, so that the detection process of this attitude can be refined from the level of the rotating assembly to the level of the first motor, so as to detect the attitude of the first motor more accurately and in real time.

In this embodiment, the motors of the rotating assembly can rotate in at least three directions, which can increase stability of the rotating assembly driving the shooting device to rotate; and among the motors, the first motor is closest to the shooting device, so the attitude of the first motor is closest to the attitude of the shooting device, and the attitude of the shooting device can be accurately estimated through the attitude of the first motor. On this basis, the joint angles of the first motor, the second motor and the third motor are determined, and at least three joint angles are used to reflect the attitude changes in at least three dimensions; then, the attitude of the first motor is converted through the joint angle of each motor, the attitude at the appropriate position of the rotating assembly is used as the attitude of the rotating assembly, and the attitude of this rotating assembly is closer to the attitude of the handle so as to more accurately determine the attitude difference between the rotating assembly and the handle.

In an optional embodiment, the joint angle range of the third motor is greater than the joint angle range of each of the first motor and the second motor, and the attitude difference includes a difference angle between the attitude of the third motor and the attitude of the handle. Determining whether the handheld gimbal is in the side-shooting mode according to the attitude difference includes: when a target axial direction of the third motor matches direction of gravity, if the difference angle exceeds a threshold, the handheld gimbal is in the side shooting mode.

The joint angle range is an angle interval that each motor can drive its own joint rotation. The joint angle range includes maximum and minimum values of the joint angle rotation, and the angle values between the maximum and minimum values. The joint angle range of the third motor is greater than the joint angle range of the second motor. That is, the difference or ratio between the maximum and minimum values of the joint angle rotation of the third motor is greater than the difference or ratio between the maximum and minimum values of the joint angle rotation of the second motor.

Since the first motor, the second motor and the third motor can rotate in different directions, and the three motors are distributed in sequence, the possibility of each motor being damaged by the pulling of cables and connecting wires is different. By limiting the range of rotation of the motor joint through the joint angle range, it is helpful to protect the safety of the load equipment. The reasons may be: on one hand, through the joint angle range, use of slip rings can be avoided, and the safety of other lines can still be guaranteed, and the reliability can be prevented from being affected by the slip rings; on the other hand, when the three joint axes are in the same plane, the control system will reach the joint singularity point, resulting in reduced accuracy. By limiting the joint angle range, the control system may be prevented from approaching the joint singularity point and avoid the situation where the motor needs a larger torque to maintain the rotation state. A larger torque to maintain the rotation state may increase energy consumption, reduce power efficiency, and even cause the motor to lose step or shake, thereby affecting the stability and accuracy of the handheld gimbal.

The difference angle may include a difference angle between the attitude of the third motor and the attitude of the handle. According to the matching of the target axial direction and the direction of gravity, it is determined whether to use the difference angle to determine whether the handheld gimbal is in the side shooting mode. Optionally, the difference angle can be in the form of quaternion, rotation matrix, or angle.

The target axial direction is a direction in the reference system established with the third motor itself as a reference. The position of the third motor in the reference coordinate system can be determined by the direction angle between the target axial direction and a certain direction in the reference coordinate system, so that the direction in which the third motor drives its own joint to rotate can be converted into the direction of the third motor in the reference coordinate system. The reference coordinate system is a coordinate system that does not use the third motor as a reference; optionally, the reference coordinate system includes but is not limited to a coordinate system established with the gimbal as a reference, a coordinate system established with the handle as a reference, a coordinate system established with the shooting device as a reference, or a world coordinate system.

The direction of gravity is, in the world coordinate system, vertically downward toward the ground.

Exemplarily, in a three-dimensional coordinate system established with the third motor 230 as the origin, the target axis includes the X-axis, Y-axis or Z-axis relative to the third motor 230; the reference coordinate system can be a world coordinate system, which includes a direction of gravity and a horizontal direction. The direction of gravity is vertically downward toward the ground, while the horizontal direction is any direction perpendicular to the direction of gravity, usually consistent with a tangent direction of the earth's surface.

In one embodiment, as shown in FIG. 4, the third motor is connected to the second motor through a shaft arm, and the shaft arm between the second motor and the third motor includes a first shaft arm 240 directly connected to the third motor and a second shaft arm 250 directly connected to the second motor. The second shaft arm 240 and the third shaft arm 250 are connected to each other to form an angle between them. In the three-dimensional coordinate system of the X axis, the Y axis, and the Z axis, the target axial direction is in a same direction as an extension direction of the first shaft arm 240 in the three-dimensional coordinate system.

In an exemplary embodiment, that when the target axial direction of the third motor 230 matches the direction of gravity, if the difference angle exceeds a threshold, the handheld gimbal is in a side shooting mode includes: when the angle between the target axial direction of the third motor 230 and the direction of gravity is less than a preset value, if the difference angle exceeds the threshold, the handheld gimbal is in the side shooting mode.

In an exemplary embodiment, that when the target axial direction of the third motor 230 matches the direction of gravity, if the difference angle exceeds a threshold, the handheld gimbal is in a side shooting mode includes: when the angle between the target axial direction of the third motor 230 and any horizontal direction of the world coordinate system is less than a preset value, if the difference angle exceeds the threshold, the handheld gimbal is in the side shooting mode; wherein the horizontal direction of the world coordinate system is perpendicular to the direction of gravity.

In an exemplary embodiment, that when the target axial direction of the third motor 230 matches the direction of gravity, if the difference angle exceeds a threshold, the handheld gimbal is in a side shooting mode includes: when a target axial rotation angle of the third motor 230 is greater than a axial rotation critical value, if the difference angle exceeds the threshold, the handheld gimbal is in the side shooting mode.

Optionally, the side shooting mode refers to a gimbal control mode in which the target axial direction and a rotation angle of the target axial direction of the third motor 230 are controlled as variables. For example, after the rotation mechanism between the handle and the third motor 230 rotates so that the target axial direction and the rotation angle of target axial direction change, until the rotation angle of the target axial direction of the third motor 230 is greater than an axial direction rotation critical value, if the difference angle exceeds the threshold, the side shooting mode is in effect.

In the side shooting mode, the controllable range of the rotating assembly in a pitch direction and the controllable range in a yaw direction are mutually adjusted. Optionally, in the side shooting mode, the third motor 230 is used as a pitch motor to increase the joint angle range in the pitch direction. Optionally, in the front shooting mode, the third motor 230 is used as a yaw motor to increase the joint angle range in the yaw direction.

In this embodiment, the joint angle range of the third motor is adjusted, so that the state between the third motor and the direction of gravity can be more finely reflected, forming a dimension for comparison of directions in different coordinate systems; in this case, when the difference angle exceeds the threshold, it can be determined that the handheld gimbal is in the side shooting mode according to the difference angle between the third motor and the handle. Therefore, whether the handheld gimbal is in the side shooting mode can be accurately determined according to two aspects, that is, the direction and the difference angle.

In a feasible embodiment, the threshold value ranges from 50 to 70 degrees.

In an exemplary embodiment, that when the target axial direction of the third motor 230 matches the direction of gravity, if the difference angle exceeds a threshold, the handheld gimbal is in a side shooting mode includes: when the target axial direction of the third motor 230 matches the direction of gravity, if the difference angle exceeds 50 degrees, the handheld gimbal is in the side shooting mode, or if the difference angle exceeds 70 degrees, the handheld gimbal is in side shooting mode, or if the difference angle exceeds 60 degrees, the handheld gimbal is in the side shooting mode.

In a feasible embodiment, the method further includes: when the target axial direction of the third motor does not match the direction of gravity, the gimbal mode is a front shooting mode.

The front shooting mode is a control mode of the handheld gimbal, which is used to control the handheld gimbal to drive the shooting device 100 to rotate. In the front shooting mode and the side shooting mode, the control mode of the rotating assembly is different. When the shooting device 100 carried by the rotating assembly is placed forward, the handheld gimbal is in the front shooting mode; when the shooting device 100 carried by the rotating assembly is placed sideways, the handheld gimbal is in the side shooting mode.

Optionally, the front shooting mode refers to a gimbal control mode in which the target axial direction and the rotation angle of the target axial direction of the third motor 230 are controlled as variables. For example, the rotation angle of the target axial direction of the third motor 230 is less than an axial rotation critical value.

Optionally, in the front shooting mode, the third motor 230 is used as a motor in the yaw direction, so that the joint angle range in the yaw direction is greater than the joint angle range in the pitch direction.

In an exemplary embodiment, that when the target axial direction of the third motor 230 does not match the direction of gravity, if the difference angle is less than a threshold, the handheld gimbal is in a front shooting mode includes: when the target axial direction of the third motor 230 does not match the direction of gravity, if the difference angle is less than 50 degrees, the handheld gimbal is in the front shooting mode, or when the target axial direction of the third motor 230 does not match the direction of gravity, if the difference angle is less than 70 degrees, the handheld gimbal is in the front shooting mode, or when the target axial direction of the third motor 230 does not match the direction of gravity, if the difference angle is less than 60 degrees, the handheld gimbal is in the front shooting mode.

Optionally, as shown in FIG. 4, in the front shooting mode, the shooting device 100 is carried on the first motor 210 through a clamp; the first motor 210, the second motor 220 and the third motor 230 can be connected in sequence through the shaft arms, and the third motor 230 is connected to the handle 300. Thus, through the shaft arm connection, the three motors can influence and coordinate with each other to achieve multi-dimensional movement of the gimbal.

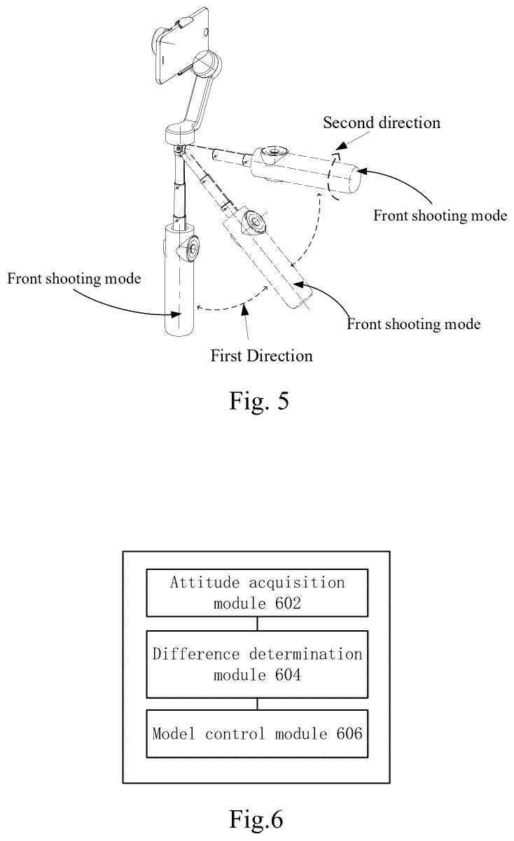

Optionally, as shown in FIG. 5, a rotating mechanism or structure is provided between the rotating assembly and the handle 300, and the relative attitude between the rotating assembly and the handle 300 can be changed by the rotating mechanism. During the change of the relative attitude, there are three scenarios of the front shooting mode, and the target axial direction of the third motor in each of these three scenarios does not match the direction of gravity. On this basis, if the relative attitude between the rotating assembly and the handle 300 is adjusted in the yaw direction and the pitch direction respectively, the target axial direction of the third motor matches the direction of gravity, so that the front shooting mode is converted to the side shooting mode.

As described above, FIGS. 4 and 5 belong to two different forms of the front shooting mode. A process from FIG. 4 to FIG. 5 and then to FIG. 3 is a process of switching from a front shooting mode to a side shooting mode. In one embodiment, the specific process includes: from FIG. 4 to FIG. 5, rotating the handle or rotating assembly of the handheld gimbal in 90 degrees along a first direction, and from FIG. 5 to FIG. 3, rotating the handle or rotating assembly of the handheld gimbal in 90 degrees along a second direction, thereby achieving the switching from the front shooting mode to the side shooting mode.

In an exemplary embodiment, the attitude of the handle 300 and the attitude of the rotating assembly are respectively detected by motion sensors, and the motion sensors include at least one of an accelerometer, a gyroscope, or a magnetometer.

An accelerometer may be a sensor that can measure linear acceleration. Optionally, the accelerometer is configured to monitor displacements of an internal detection mass to determine the acceleration, and these displacements are converted into electrical signals for output. Optionally, the accelerometer can be used not only to detect dynamic acceleration during movement, but also to sense gravity acceleration, thereby calculating a tilt angle of the rotating assembly or handle 300 relative to the direction of gravity. The accelerometer can be a three-axis accelerometer or an accelerometer with other axes.

A gyroscope may be configured to measure an angular velocity or rotational motion of a device. The gyroscope works based on the gyroscopic effect, which is tendency of a spinning wheel to maintain the same direction of its axis of rotation. The gyroscope can be a three-axis gyroscope or a gyroscope with other number of axes.

A magnetometer may be configured to measure a strength of magnetic field in the environment and its direction. The magnetometer may sense the Earth's magnetic field to determine absolute direction.

Optionally, the attitude of the rotating assembly may be the attitude of the third motor 230. In this case, the attitude of the third motor 230 may be detected by at least one of an accelerometer, a gyroscope or a magnetometer.

Optionally, the motion sensor may be an inertial measurement unit (IMU), which includes an accelerometer, a gyroscope, or a magnetometer, so as to output the attitude of the corresponding part through the inertial measurement unit.

In an optional embodiment, the method also includes: determining a shaking amplitude and a shaking frequency of the handle 300 based on the acceleration data detected by the accelerometer, and controlling the rotation of the rotating assembly according to the shaking amplitude and the shaking frequency; or, determining the shaking amplitude and the shaking frequency of the handle 300 based on the acceleration data detected by the accelerometer, and obtaining the gyroscope data detected by the gyroscope; and controlling the rotation of the rotating assembly according to the shaking amplitude, the shaking frequency and the gyroscope data.

The shaking amplitude is an amplitude of shaking of the handle 300; the shaking frequency is the frequency at which the handle 300 reaches a certain shaking amplitude or amplitudes; and the gyroscope data is a rotation angle detected by the gyroscope.

In an optional embodiment, determining the shaking amplitude and the shaking frequency of the handle 300 based on the acceleration data detected by the accelerometer includes: obtaining acceleration data in a time domain based on the acceleration data at multiple moments; performing Fourier transformation on the acceleration data in the time domain to obtain acceleration data in a frequency domain; and obtaining the shaking amplitude and the shaking frequency based on the acceleration data in the frequency domain. Among them, the acceleration data in the time domain is the acceleration data arranged in sequence through a time series; the acceleration data in the frequency domain is the acceleration data arranged in sequence through the frequencies of the shaking amplitude. Thus, different shaking amplitudes and their frequencies are revealed by the Fourier transformation.

In another optional embodiment, the determining the shaking amplitude and the shaking frequency of the handle 300 based on the acceleration data detected by the accelerometer includes: identifying the shaking amplitude and the shaking frequency of the acceleration data through waveform characteristics of the acceleration data; wherein the waveform characteristics include but are not limited to a rising edge, a falling edge, a difference or ratio between the rising edge and the falling edge.

In an optional implementation, the controlling the rotation of the rotating assembly according to the shaking amplitude and the shaking frequency includes: searching a mapping table for a control coefficient corresponding to the shaking amplitude and the shaking frequency; and controlling the rotation of the rotating assembly according to the control coefficient.

In another optional implementation, the controlling the rotation of the rotating assembly according to the shaking amplitude and the shaking frequency includes: substituting the shaking amplitude and the shaking frequency into an objective function to obtain a corresponding control coefficient; and controlling the rotation of the rotating assembly according to the control coefficient.

In an optional implementation, the controlling the rotation of the rotating assembly according to the shaking amplitude, the shaking frequency and the gyroscope data includes: searching a mapping table for a control coefficient corresponding to the shaking amplitude, the shaking frequency and the gyroscope data, and controlling the rotation of the rotating assembly according to the control coefficient.

In another optional implementation, the controlling the rotation of the rotating assembly according to the shaking amplitude, the shaking frequency and the gyroscope data includes: substituting the shaking amplitude, the shaking frequency and the gyroscope data into the objective function to obtain a corresponding control coefficient, and controlling the rotation of the rotating assembly according to the control coefficient.

In this embodiment, the rotation of the rotating assembly is controlled according to the shaking amplitude and the shaking frequency, and the shaking and frequency of the handle 300 can be stabilized. Even if the user holds the handle 300 to move, the image can be quickly and stably collected with a small amount of data. By controlling the rotation of the rotating assembly according to the shaking amplitude, the shaking frequency and the gyroscope data, the image can be collected more stably.

In an exemplary embodiment, the rotating assembly includes a shaft arm and a motor, and the motor drives the shaft arm to rotate to drive the shooting device 100. The method further includes: when the handheld gimbal is switched to the side shooting mode, the shaft arm is controlled to avoid appearing in field of view of the shooting device 100 by controlling the rotation path of the shaft arm; and/or when the handheld gimbal is switched to the front shooting mode, the shaft arm is controlled to avoid appearing in the shooting image of the shooting device 100 by controlling the rotation path of the shaft arm.

The rotation path is a path in which the motor drives the joint to rotate so that the shaft arm changes its position. Optionally, the rotation path can be a path in which at least one of the first motor 210, the second motor 220 and the third motor 230 drives the position of the shaft arm to change.

The field of view is an image collected by the shooting device 100. Optionally, an image collection direction of the shooting device 100 is controlled by controlling the rotation path of the shaft arm to prevent the shaft arm from appearing in the field of view of the shooting device 100.

In an optional embodiment, the method further includes: when the handheld gimbal is switched to the side shooting mode, controlling the rotation path of the shaft arm to prevent the shaft arm from appearing in the field of view of the shooting device 100.

In another optional embodiment, the method further includes: when the handheld gimbal is switched to the front shooting mode, controlling the rotation path of the shaft arm to prevent the shaft arm from appearing in the field of view of the shooting device 100.

In another optional embodiment, the method further includes: when the handheld gimbal is switched to the side shooting mode, controlling the rotation path of the shaft arm to prevent the shaft arm from appearing in the field of view e of the shooting device 100; when the handheld gimbal is switched to the front shooting mode, controlling the rotation path of the shaft arm to prevent the shaft arm from appearing in the field of view of the shooting device 100.

In one embodiment, a rotating mechanism or structure is provided between the rotating assembly and the handle 300, and the relative attitude between the rotating assembly and the handle 300 is changed by the rotating structure to realize the switching of the control mode between the front shooting mode and the side shooting mode. Specifically, if the relative attitude is adjusted in the yaw direction and the pitch direction respectively, the target axial direction of the third motor matches the direction of gravity, so that the front shooting mode is converted to the side shooting mode.

Optionally, when switching between the front shooting mode and the side shooting mode, a same or different algorithms may be used to control the rotation path of the shaft arm to prevent the shaft arm from appearing in the field of view of the shooting device 100. For example, a spherical linear interpolation algorithm and singular point avoidance may be used to control the rotation path of the shaft arm; a trained neural network model may also be used to control the rotation path of the shaft arm.

In an exemplary embodiment, the rotating assembly includes a yaw motor and a pitch motor; the method also includes: when the handheld gimbal switches from a front shooting mode to a side shooting mode, any one of the yaw motor or the pitch motor switches to the other motor; and/or when the handheld gimbal switches from a side shooting mode to a front shooting mode, any one of the yaw motor or the pitch motor switches to the other motor.

The yaw motor may be configured to control a horizontal rotation of the shooting device 100, that is, to change the yaw angle of the shooting device 100. The pitch motor is configured to control the pitching of the shooting device 100, that is, to support the shooting device 100 to adjust the viewing angle vertically upward or downward.

The yaw motor and the pitch motor may have some similarities. Optionally, a brushless DC motor or a servo motor may be used to achieve precise control and fast response. Optionally, both the yaw motor and the pitch motor have built-in encoders and sensors to provide real-time position and speed feedback to ensure that the motor movements are accurate and consistent with the control instructions. Optionally, both the yaw motor and the pitch motor are equipped with sensors such as gyroscopes and accelerometers and control algorithms to maintain the stability of the attitude of the shooting device 100.

The yaw motor and the pitch motor may have differences. Optionally, for the terminal implementing this embodiment, the processor thereof sets different algorithms for the yaw motor and the pitch motor, and thus switches between the yaw motor and the pitch motor, so that the motors controlled by the algorithms are switched.

Optionally, the yaw motor and the pitch motor have different joint angle ranges, and by switching in this way, the yaw motor and the pitch motor can be swapped. For example, in the side shooting mode, the degrees of freedom of the handheld gimbal in the yaw and pitch directions are changed, thereby expanding the controllable range of the gimbal in the pitch directions.

For example, in the front shooting mode, the second motor 220 can be used as a pitch motor, and the third motor 230 can be used as a yaw motor, so that the joint angle range in the yaw direction is larger; in the side shooting mode, the second motor 220 can be used as a yaw motor, and the third motor 230 can be used as a pitch motor, so that the joint angle range in the pitch direction is larger. Optionally, the first motor 210 is always used as a roll axis motor.

In this embodiment, there are three specific switching scenarios in the control mode of the handheld gimbal, and these three specific switching scenarios all involve the mutual switching of the yaw motor and the pitch motor. Thus, any motor of the yaw motor or the pitch motor is switched to the other motor, realizing the switching between the yaw motor and the pitch motor, so as to efficiently and accurately adjust the shooting device 100 in terms of the joint angle range in different directions.

In an exemplary embodiment, the method further includes: when the handheld gimbal switches to the side shooting mode, transmitting prompt information of the side shooting mode through the shooting device 100 or the handheld gimbal, wherein the prompt information is configured to express that the handheld gimbal is in the side shooting mode.

The prompt information may be configured to express that the handheld gimbal is in the side shooting mode. Optionally, the prompt information may be information transmitted through sound, light, electricity, force, heat or other dimensions.

In an optional implementation, the transmitting the prompt information of the side shooting mode through the shooting device 100 or the handheld gimbal includes: displaying the prompt information of the side shooting mode through an interface of the shooting device 100 or an interface of the handheld gimbal.

In another optional embodiment, transmitting the prompt information of the side shooting mode through the shooting device 100 or the handheld gimbal includes: transmitting a signal configured to represent the prompt information through the shooting device 100 or the handheld gimbal, the signal including but not limited to a brain-computer signal, a chemical signal, an audio signal, a texture change signal or other sensory signals.

In one embodiment, an IMU sensor is installed on the first motor 210 of the handheld gimbal to obtain the attitude of the first motor 210 of the gimbal or the mobile phone connected to the first motor 210. Then, angle sensors are installed on the first, second, and third motors 230 to detect the rotation angles of the corresponding motors and obtain the joint angles. Then, the attitude of the third motor 230 is calculated using the attitude of the first motor 210 of the gimbal and the three joint angles. Another IMU sensor is provided on the handle 300 to obtain the attitude of the handle 300.

Next, an angle between the attitude of the third motor 230 and the attitude of the handle 300 is used to calculate a difference angle between the rotating assembly and the handle 300. If the difference angle exceeds a certain threshold, it is considered to be in a side shooting mode, and the threshold range is 50-70 degrees. If the difference angle does not exceed this threshold, it is not in the side shooting mode.

The IMU sensor on the handle 300 may include at least a three-axis accelerometer, or a three-axis accelerometer plus a three-axis gyroscope, or a three-axis accelerometer plus a three-axis gyroscope plus a three-axis magnetometer. The acceleration data on the handle 300 can be used to calculate the amplitude and frequency of handle shaking. The gyroscope data on the handle 300 can be used to make the gimbal better follow the rotation of the handle 300.

Therefore, whether the current mode is in the side shooting mode is determined by the difference between the attitude of the handle 300 and the attitude of the gimbal. In the side shooting mode, the third motor 230 provides the degree of freedom of the gimbal in the pitch direction, thereby expanding the controllable range of the gimbal in the pitch direction. In the switching process of the side shooting mode, in order to prevent the shaft arm from blocking the camera, the shaft arm is controlled to rotate to a position in a path avoiding being imaged by the shooting device. In the switching process of the side shooting mode, the singularity point of the gimbal will be passed, and the motor angle control is used to make the gimbal pass the singularity point smoothly. After switching to the side shooting mode, the software limits of the Yaw-axis and the Pitch-axis relative to the structure will be exchanged with each other. After switching to the side shooting mode, a message is sent to the mobile phone to remind the user that it is in the side shooting mode, and to provide shooting guidance, such as low-angle or high-angle shooting.

Therefore, the difference angle between the rotating assembly and the handle 300 is determined by using the difference between the attitude of the third motor 230 and the attitude of the handle 300. At the same time, the amplitude and frequency of handle shaking can be calculated by using the acceleration data on the handle 300, and the gyroscope data on the handle 300 can make the gimbal better follow the rotation of the handle 300; and the side shooting mode detection includes determining whether it is currently in the side shooting mode by the difference between the attitude of the handle 300 and the attitude of the gimbal; in the side shooting mode, the third motor 230 provides the degree of freedom of the gimbal in the pitch direction, thereby expanding the controllable range of the gimbal in the pitch direction; and in the side shooting mode, in order to prevent the shaft arm from blocking the camera, the shaft arm is controlled to rotate to a position away from the shooting device.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in this disclosure, the execution of these steps does not have a strict order restriction, and these steps can be executed in other orders. Moreover, at least a part of the steps in the flowcharts involved in the above-mentioned embodiments can include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, one embodiment of the present application also provides a handheld gimbal control device for implementing the handheld gimbal control method involved above. The implementation scheme for solving the problem provided by the device is similar to the implementation scheme recorded in the above method, so the specific limitations in the embodiments of one or more handheld gimbal control devices provided below can refer to the limitations of the handheld gimbal control method above, and will not be repeated here.

In one embodiment, as shown in FIG. 6, a control device or controller for a handheld gimbal is provided, wherein the gimbal comprises a rotating assembly and a handle of the rotating assembly, wherein the rotating assembly is used to drive a shooting device to rotate, and the control device comprises:
an attitude acquisition module or circuitry 602, configured to acquire an attitude of the rotating assembly and an attitude of the handle;
a difference determination module or circuitry 604, configured to determine an attitude difference between the rotating assembly and the handle according to the attitude of the rotating assembly and the attitude of the handle; and
a mode control module or circuitry 606, configured to determine whether the handheld gimbal is in a side shooting mode according to the attitude difference.

In one of the embodiments, the attitude of the rotating assembly is determined by a motion sensor on the rotating assembly or a motion sensor on the shooting device, and the attitude of the handle is detected by a motion sensor provided in the handle.

In one embodiment, the rotating assembly includes a motor; the attitude acquisition module 602 is configured to:
detect a joint angle of the motor and an attitude of the motor;
according to the joint angle of the motor, convert the attitude of the motor into the attitude of the rotating assembly; and
obtain the attitude of the handle.

In one embodiment, the motor includes a first motor, a second motor and a third motor rotating in different directions, and the first motor, the second motor and the third motor are sequentially distributed between the shooting device and the handle; the attitude acquisition module 602 is configured to:
determine the joint angles of the first motor, the second motor, and the third motor; and
converting the attitude of the first motor through the joint angles of the motors to obtain the attitude of the rotating assembly.

In one embodiment, the first motor is connected to the shooting device, the third motor is connected to the handle, the attitude of the third motor is obtained by converting the attitude of the first motor through the joint angle of each motor, and the attitude of the third motor is the attitude of the rotating assembly.

In one embodiment, the attitude acquisition module 602 is configured to:
determine a rotation matrix of the first motor, a rotation matrix of the second motor, and a rotation matrix of the third motor according to the respective joint angles of the first motor, the second motor, and the third motor; and
combining the attitude of the first motor with the rotation matrix of the first motor, the rotation matrix of the second motor and the rotation matrix of the third motor to obtain the attitude of the rotating assembly.

In one embodiment, the attitude of the first motor is determined by a motion sensor on the first motor or a motion sensor on the shooting device.

In one embodiment, the first motor, the second motor and the third motor are respectively provided with an angle sensor;

The attitude acquisition module 602 is configured to:
use the angle sensors to detect joint angles of the first motor, the second motor, and the third motor respectively.

In one embodiment, the joint angle range of the third motor is greater than the joint angle ranges of the first motor and the second motor, respectively, and the attitude difference includes a difference angle between the attitude of the third motor and the attitude of the handle.

The mode control module 606 is configured to:
when the target axial direction of the third motor matches the direction of gravity, if the difference angle exceeds a threshold, determine that the handheld gimbal is in a side-shooting mode.

In one embodiment, the value of the threshold ranges from 50 to 70 degrees.

In one embodiment, the mode control module 606 is configured to:
when the target axial direction of the third motor does not match the direction of gravity, determine that the gimbal mode is a front shooting mode.

In one embodiment, the attitude of the handle and the attitude of the rotating assembly are respectively detected by motion sensors, and the motion sensor includes at least one of an accelerometer, a gyroscope or a magnetometer.

In one embodiment, the mode control module 606 is configured to:
determine a shaking amplitude and a shaking frequency of the handle according to the acceleration data detected by the accelerometer, and control the rotation of the rotating assembly according to the shaking amplitude and the shaking frequency; or,
determine the shaking amplitude and the shaking frequency of the handle according to the acceleration data detected by the accelerometer, and obtain the gyroscope data detected by the gyroscope; and control the rotation of the rotating assembly according to the shaking amplitude, the shaking frequency and the gyroscope data.

In one embodiment, the rotating assembly includes a shaft arm and a motor, and the motor drives the shaft arm to rotate to drive the shooting device to rotate. The mode control module 606 is configured to:
when the handheld gimbal is switched to the side shooting mode, control a rotation path of the shaft arm to prevent the shaft arm from appearing in the shooting image of the shooting device; and/or
when the handheld gimbal is switched to the front shooting mode, control a rotation path of the shaft arm to prevent the shaft arm from appearing in the shooting image of the shooting device.

In one embodiment, the rotating assembly includes a yaw motor and a pitch motor; the mode control module 606 is configured to:
when the handheld gimbal is switched from the front shooting mode to the side shooting mode, switch any one of the yaw motor or the pitching motor to the other motor; and/or
when the handheld gimbal is switched from the side shooting mode to the front shooting mode, switch any one of the yaw motor or the pitch motor to the other motor.

In one embodiment, the mode control module 606 is configured to:
when the handheld gimbal switches to the side shooting mode, transmit prompt information of the side shooting mode through the shooting device or the handheld gimbal, wherein the prompt information is configured to express that the handheld gimbal is in the side shooting mode.

Each module in the control device of the handheld gimbal can be implemented in whole or in part by software, hardware, or a combination thereof. Each module can be embedded in or independent of a processor or circuitry in a computer device in the form of hardware, or can be stored in a memory in a computer device in the form of software, so that the processor can call and execute operations corresponding to each module.

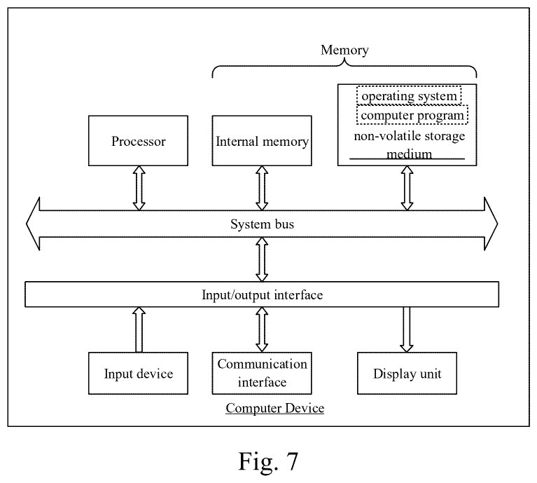

In one embodiment, a computer device is provided, which may be a terminal, and its internal structure diagram may be shown in FIG. 7. The computer device includes a processor, a memory, an input/output interface, a communication interface, a display unit, and an input device. The processor, the memory, and the input/output interface are connected via a system bus, and the communication interface, the display unit, and the input device are connected to the system bus via the input/output interface. The processor of the computer device is used to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The input/output interface of the computer device is configured to exchange information between the processor and an external device. The communication interface of the computer device is configured to communicate with an external terminal in a wired or wireless manner, and the wireless manner can be implemented through WIFI, a mobile cellular network, NFC (near field communication) or other technologies. When the computer program is executed by the processor, a control method for a handheld gimbal is implemented. The display unit of the computer device is configured to form a visually visible image, and can be a display screen, a projection device or a virtual reality imaging device. The display screen can be a liquid crystal display screen or an electronic ink display screen. The input device of the computer device can be a touch layer covered on the display screen, or a button, trackball or touchpad set on the computer device casing, or an external keyboard, touchpad or mouse, etc.

Those skilled in the art will understand that the structure shown in FIG. 7 is merely a block diagram of a partial structure related to the solution of the present application, and does not constitute a limitation on the computer device to which the solution of the present application is applied. The specific computer device may include more or fewer components than those shown in the figure, or combine certain components, or have a different arrangement of components.

In one embodiment, the present application also provides a handheld gimbal, which includes a handle and a rotating assembly connected to the handle, the rotating assembly is used to carry a shooting device and drive the shooting device to rotate, and the handheld gimbal also includes: an attitude acquisition element, which is arranged on the rotating assembly or the handle, and detects the attitude of the rotating assembly and the attitude of the handle; a controller, and when the computer program is executed by the controller, the steps in one of the above-mentioned method embodiments are implemented.

In one embodiment, a computer device is further provided, including a memory and a processor, wherein a computer program is stored in the memory, and the processor implements the steps in one of the above method embodiments when executing the computer program.

In one embodiment, a computer-readable storage medium is provided, on which a computer program is stored. When the computer program is executed by a processor, the steps in one of the above-mentioned method embodiments are implemented.

In one embodiment, a computer program product is provided, including a computer program, which implements the steps in one of the above method embodiments when executed by a processor.

It should be noted that the user information (including but not limited to user device information, user personal information, etc.) and data (including but not limited to data used for analysis, stored data, displayed data, etc.) involved in this application are all information and data authorized by the user or fully authorized by all parties, and the collection, use and processing of relevant data must comply with relevant laws, regulations and standards.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can include the processes of one of the embodiments of the above-mentioned methods. Among them, any reference to the memory, database or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing unit, a graphics processor, a digital signal processor, a programmable logic unit, a data processing logic unit based on quantum computing, circuitry, etc., but are not limited to this.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-described embodiments only express several implementation methods of the present application, and the descriptions thereof are relatively specific and detailed, but they cannot be understood as limiting the scope of the present application. It should be pointed out that, for a person of ordinary skill in the art, several modifications and improvements can be made without departing from the concept of the present application, and these all belong to the protection scope of the present application. Therefore, the protection scope of the present application shall be subject to the attached claims.

What is claimed is:

1. A control method for a handheld gimbal, the handheld gimbal comprising a handle, a rotating assembly connected to the handle, the rotating assembly configured to carry a shooting device and drive the shooting device to rotate, the control method comprising:
acquiring an attitude of the rotating assembly and an attitude of the handle;
determining an attitude difference between the rotating assembly and the handle according to the attitude of the rotating assembly and the attitude of the handle; and
determining that the handheld gimbal is in a side shooting mode according to the attitude difference.

2. The method according to claim 1, wherein the acquiring the attitude of the rotating assembly and the attitude of the handle comprises:
detecting the attitude of the rotating assembly by a motion sensor on the rotating assembly or a motion sensor on the shooting device; and
detecting the attitude of the handle by a motion sensor in the handle.

3. The method according to claim 1, wherein the rotating assembly comprises a motor; and the acquiring the attitude of the rotating assembly comprises:
detecting a joint angle of the motor and an attitude of the motor; and
converting the attitude of the motor into the attitude of the rotating assembly through the joint angle of the motor.

4. The method according to claim 3, wherein the motor comprises a first motor, a second motor and a third motor rotating in different directions, and the first motor, the second motor and the third motor are sequentially distributed between the shooting device and the handle;
the converting the attitude of the motor into the attitude of the rotating assembly through the joint angle of the motor comprises:
determine respective joint angles of the first motor, the second motor, and the third motor; and
converting the attitude of the first motor through the respective joint angles of the first motor, the second motor, and the third motor to obtain the attitude of the rotating assembly.

5. The method according to claim 4, wherein the first motor is connected to the shooting device and the third motor is connected to the handle, the converting the attitude of the first motor through the respective joint angles of the first motor, the second motor, and the third motor to obtain the attitude of the rotating assembly comprises:
obtaining the attitude of the third motor by converting the attitude of the first motor through the respective joint angles of the first motor, the second motor, and the third motor; and
determining the attitude of the third motor as the attitude of the rotating assembly.

6. The method according to claim 4, wherein the converting the attitude of the first motor through the respective joint angles of the first motor, the second motor, and the third motor to obtain the attitude of the rotating assembly comprises:
determining a rotation matrix of the first motor, a rotation matrix of the second motor, and a rotation matrix of the third motor according to the respective joint angles of the first motor, the second motor, and the third motor; and
combining the attitude of the first motor with the rotation matrix of the first motor, the rotation matrix of the second motor and the rotation matrix of the third motor to obtain the attitude of the rotating assembly.

7. The method according to claim 4, wherein the attitude of the first motor is determined by a motion sensor on the first motor or a motion sensor on the shooting device.

8. The method according to claim 4, wherein the first motor, the second motor and the third motor are respectively provided with angle sensors;
the determining the respective joint angles of the first motor, the second motor, and the third motor comprises:
using the angle sensors to detect the respective joint angles of the first motor, the second motor, and the third motor.

9. The method according to claim 4, wherein a joint angle range of the third motor is greater than a joint angle range of the second motor and the attitude difference comprises a difference angle between the attitude of the third motor and the attitude of the handle;
the determining that the handheld gimbal is in the side shooting mode according to the attitude difference comprises:
detecting that a target axial direction of the third motor matches a gravity direction and that the difference angle exceeds a threshold; and
determining that the handheld gimbal is in the side shooting mode.

10. The method according to claim 9, wherein a value of the threshold ranges from 50 to 70 degrees.

11. The method according to claim 1, wherein the attitude of the handle and the attitude of the rotating assembly are respectively detected by motion sensors, and the motion sensors include at least one of an accelerometer, a gyroscope or a magnetometer.

12. The method according to claim 11, further comprising:
determining a shaking amplitude and a shaking frequency of the handle according to acceleration data detected by the accelerometer, and controlling rotation of the rotating assembly according to the shaking amplitude and the shaking frequency; or
determining the shaking amplitude and the shaking frequency of the handle according to the acceleration data detected by the accelerometer and gyroscope data detected by the gyroscope; and controlling the rotation of the rotating assembly according to the shaking amplitude, the shaking frequency and the gyroscope data.

13. The method according to claim 1, wherein the rotating assembly comprises a shaft arm and a motor, and the motor drives the shaft arm to rotate so as to drive the shooting device to rotate, and the control method further comprising:
controlling a rotation path of the shaft arm to prevent the shaft arm from appearing in the field of view of the shooting device during the transition of the handheld gimbal to the side shooting mode, and/or
controlling the rotation path of the shaft arm to prevent the shaft arm from appearing in the field of view of the shooting device during the transition of the handheld gimbal to a front shooting mode.

14. The method according to claim 1, wherein the rotating assembly comprises a yaw motor and a pitch motor; the control method further comprising:
determining that the handheld gimbal is switched from a front shooting mode to the side shooting mode; and
switching any one of the yaw motor or the pitch motor to the other one, and/or
determining that the handheld gimbal is switched from the side shooting mode to the front shooting mode; and
switching any one of the yaw motor or the pitch motor to the other one.

15. The method according to claim 1, further comprising:
determining that the handheld gimbal is switched to the side shooting mode; and
transmitting prompt information of the side shooting mode through the shooting device or the handheld gimbal,
wherein the prompt information is configured to express that the handheld gimbal is in the side shooting mode.

16. A handheld gimbal, comprising a handle and a rotating assembly connected to the handle, the rotating assembly configured to carry a shooting device and drive the shooting device to rotate, and the handheld gimbal further comprises circuitry configured to:
acquire an attitude of the rotating assembly and an attitude of the handle;
determine an attitude difference between the rotating assembly and the handle according to the attitude of the rotating assembly and the attitude of the handle; and
determine that the handheld gimbal is in a side shooting mode according to the attitude difference.

17. The handheld gimbal of claim 16, further comprising a motion sensor on the rotating assembly or a motion sensor on the shooting device to detect the attitude of the rotating assembly; and
a motion sensor in the handle to detect the attitude of the handle.

18. The handheld gimble of claim 16, wherein the rotating assembly comprises a motor; and the acquiring the attitude of the rotating assembly comprises:
detecting a joint angle of the motor and an attitude of the motor; and
converting the attitude of the motor into the attitude of the rotating assembly through the joint angle of the motor.

19. The handheld gimble according to claim 16, wherein the rotating assembly comprises a shaft arm and a motor, and the motor drives the shaft arm to rotate so as to drive the shooting device to rotate, and the circuitry is further configured to:
control a rotation path of the shaft arm to prevent the shaft arm from appearing in the field of view of the shooting device during the transition of the handheld gimbal to the side shooting mode, and/or
control the rotation path of the shaft arm to prevent the shaft arm from appearing in the field of view of the shooting device during the transition of the handheld gimbal to a front shooting mode.

20. The handheld gimble according to claim 16, wherein the rotating assembly comprises a yaw motor and a pitch motor; the circuitry is further configured to:
determine that the handheld gimbal is switched from a front shooting mode to the side shooting mode; and
switch any one of the yaw motor or the pitch motor to the other one, and/or
determine that the handheld gimbal is switched from the side shooting mode to the front shooting mode; and
switch any one of the yaw motor or the pitch motor to the other one.
